(19) United States
(12) Patent Application Publication
(10) Pub. No.: US 2022/0230648 A1
(43) Pub. Date: Jul. 21, 2022

(54) METHOD, SYSTEM, AND NON-TRANSITORY COMPUTER READABLE RECORD MEDIUM FOR SPEAKER DIARIZATION COMBINED WITH SPEAKER IDENTIFICATION

(71) Applicants: NAVER CORPORATION, Seongnam-si (KR); LINE CORPORATION, Tokyo (JP)

(72) Inventors: Youngki Kwon, Seongnam-si (KR); Han Yong Kang, Seongnam-si (KR); You Jin Kim, Seongnam-si (KR); Han-Gyu Kim, Seongnam-si (KR); Bong-Jin Lee, Seongnam-si (KR); Junghoon Jang, Seongnam-si (KR); Icksang Han, Seongnam-si (KR); Hee Soo Heo, Seongnam-si (KR); Joon Son Chung, Seongnam-si (KR)

(21) Appl. No.: 17/576,492

(22) Filed: Jan. 14, 2022

(30) Foreign Application Priority Data
Jan. 15, 2021 (KR) 10-2021-0006190

(51) Int. Cl. G10L 21/028; G10L 17/06

(52) U.S. Cl. CPC G10L 21/028; G10L 17/06

(57) ABSTRACT

Provided is a method, system, and non-transitory computer-readable record medium for speaker diarization combined with speaker identification. Provided is a speaker diarization method including setting a reference speech in relation to an audio file received as a speaker diarization target speech from a client; performing a speaker identification of identifying a speaker of the reference speech in the audio file using the reference speech; and performing a speaker diarization using clustering on a remaining utterance section unidentified in the audio file.

### CROSS-REFERENCE TO RELATED APPLICATION(S)

This U.S. non-provisional application claims the benefit of priority under 35 U.S.C. § 119 to Korean Patent Application No. 10-2021-0006190 filed on Jan. 15, 2021, in the Korean Intellectual Property Office (KIPO), the entire contents of which are incorporated herein by reference.

### BACKGROUND OF THE INVENTION

### Field of Invention

One or more example embodiments of the following description relate to speaker diarization technology.

### Description of Related Art

Speaker diarization refers to technology for separating an utterance section for each speaker from an audio file in which contents uttered by a plurality of speakers are recorded.

The speaker diarization technology relates to detecting a speaker boundary section from audio data, and such technology may be considered as being divided into a distance-based scheme and a model-based scheme, depending on whether prior knowledge about a speaker is used.

For example, technology for tracking a location of a speaker and separating a speech of the speaker from an input sound based on speaker location information is disclosed in Korean Patent Laid-Open Publication No. 10-2020-0036820, published on Apr. 7, 2020.

The speaker diarization technology refers to general technology that separates and automatically records utterance content for each speaker in a situation when a plurality of speakers are making utterances out of sequence, such as in a meeting, an interview, a transaction, and a trial, and such technology may be used for writing automatic meeting minutes.

### BRIEF SUMMARY OF THE INVENTION

One or more example embodiments provide a method and system that may improve speaker diarization performance by combining speaker diarization technology with speaker identification technology.

One or more example embodiments provide a method and system that may perform speaker identification and then perform speaker diarization using a reference speech including a speaker label.

According to an aspect of at least one example embodiment, there is provided a speaker diarization method executed by a computer system including at least one processor configured to execute computer-readable instructions included in a memory, the speaker diarization method including, by the at least one processor, setting a reference speech in relation to an audio file received as a speaker diarization target speech from a client; performing a speaker identification of identifying a speaker of the reference speech in the audio file using the reference speech; and performing a speaker diarization using clustering on a remaining unidentified utterance section in the audio file.

The setting of the reference speech may include setting speech data including a label of at least a portion (subset) of the speakers included in the audio file as the reference speech.

The setting of the reference speech may include receiving a selection on a speech of a portion of speakers included in the audio file from among speaker speeches pre-stored in a database related to the computer system, and setting the selected speech as the reference speech.

The setting of the reference speech may include receiving an input of a speech of a portion (subset) of the speakers included in the audio file through recording, and setting the input speech as the reference speech.

The performing of the speaker identification may include verifying an utterance section corresponding to the reference speech among utterance sections included in the audio file; and mapping a speaker label of the reference speech to the utterance section corresponding to the reference speech.

The verifying may include verifying the utterance section corresponding to the reference speech based on a distance between an embedding extracted from the utterance section and an embedding extracted from the reference speech.

The verifying may include verifying the utterance section corresponding to the reference speech based on a distance between an embedding cluster that is a result of clustering an embedding extracted from the utterance section and an embedding extracted from the reference speech.

The verifying may include verifying the utterance section corresponding to the reference speech based on a result of clustering an embedding extracted from the reference speech with an embedding extracted from the utterance section.

The performing of the speaker diarization may include clustering an embedding extracted from the remaining utterance section; and mapping an index of a cluster to the remaining utterance section.

The clustering may include calculating an affinity matrix based on the embedding extracted from the remaining utterance section; extracting eigenvalues by performing an eigen decomposition on the affinity matrix; sorting the extracted eigenvalues and determining a number of eigenvalues selected based on a difference between adjacent eigenvalues as a number of clusters; and performing a speaker diarization clustering using the affinity matrix and the number of clusters.

According to an aspect of at least one example embodiment, there is provided a non-transitory computer-readable record medium storing instructions that, when executed by a processor, cause the processor to computer-implement the speaker diarization method.

According to an aspect of at least one example embodiment, there is provided a computer system including at least one processor configured to execute computer-readable instructions included in a memory. The at least one processor includes a reference setter configured to set a reference speech in relation to an audio file received as a speaker diarization target speech from a client; a speaker identifier configured to perform a speaker identification of identifying a speaker of the reference speech in the audio file using the reference speech; and a speaker diarizer configured to perform a speaker diarization using clustering on a remaining utterance section unidentified in the audio file.

According to some example embodiments, it is possible to improve speaker diarization performance by combining speaker diarization technology with speaker identification technology.

According to some example embodiments, it is possible to improve the accuracy of speaker diarization technology by performing a speaker identification and then performing a speaker diarization using a reference speech including a speaker label.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

Example embodiments will be described in more detail with regard to the figures, wherein like reference numerals refer to like parts throughout the various figures unless otherwise specified, and wherein:

FIG. 1 is a diagram illustrating an example of a network environment according to at least one example embodiment;

FIG. 2 is a diagram illustrating an example of a computer system according to at least one example embodiment;

FIG. 3 is a diagram illustrating an example of a component includable in a processor of a computer system according to at least one example embodiment;

FIG. 4 is a flowchart illustrating an example of a speaker diarization method performed by a computer system according to at least one example embodiment;

FIG. 5 illustrates an example of a speaker identification process according to at least one example embodiment;

FIG. 6 illustrates an example of a speaker diarization process according to at least one example embodiment;

FIG. 7 illustrates an example of a speaker diarization process combined with a speaker identification process according to at least one example embodiment; and

FIGS. 8 to 10 illustrate examples of a method of verifying an utterance section corresponding to a reference speech according to at least one example embodiment.

It should be noted that these figures are intended to illustrate the general characteristics of methods and/or structure utilized in certain example embodiments and to supplement the written description provided below. These drawings are not, however, to scale and may not precisely reflect the precise structural or performance characteristics of any given embodiment, and should not be interpreted as defining or limiting the range of values or properties encompassed by example embodiments.

### DETAILED DESCRIPTION OF THE INVENTION

One or more example embodiments will be described in detail with reference to the accompanying drawings. Example embodiments, however, may be embodied in various different forms, and should not be construed as being limited to only the illustrated embodiments. Rather, the illustrated embodiments are provided as examples so that this disclosure will be thorough and complete, and will fully convey the concepts of this disclosure to those skilled in the art. Accordingly, known processes, elements, and techniques, may not be described with respect to some example embodiments. Unless otherwise noted, like reference characters denote like elements throughout the attached drawings and written description, and thus descriptions will not be repeated.

Although the terms “first,” “second,” “third,” etc., may be used herein to describe various elements, components, regions, layers, and/or sections, these elements, components, regions, layers, and/or sections, should not be limited by these terms. These terms are only used to distinguish one element, component, region, layer, or section, from another region, layer, or section. Thus, a first element, component, region, layer, or section, discussed below may be termed a second element, component, region, layer, or section, without departing from the scope of this disclosure.

Spatially relative terms, such as “beneath,” “below,” “lower,” “under,” “above,” “upper,” and the like, may be used herein for ease of description to describe one element or feature's relationship to another element(s) or feature s) as illustrated in the figures. It will be understood that the spatially relative terms are intended to encompass different orientations of the device in use or operation in addition to the orientation depicted in the figures. For example, if the device in the figures is turned over, elements described as “below,” “beneath,” or “under,” other elements or features would then be oriented “above” the other elements or features. Thus, the example terms “below” and “under” may encompass both an orientation of above and below. The device may be otherwise oriented (rotated 90 degrees or at other orientations) and the spatially relative descriptors used herein interpreted accordingly. In addition, when an element is referred to as being “between” two elements, the element may be the only element between the two elements, or one or more other intervening elements may be present.

As used herein, the singular forms “a,” “an,” and “the,” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups, thereof. As used herein, the term “and/or” includes any and all combinations of one or more of the associated listed products. Expressions such as “at least one of,” when preceding a list of elements, modify the entire list of elements and do not modify the individual elements of the list. Also, the term “exemplary” is intended to refer to an example or illustration.

When an element is referred to as being “on,” “connected to,” “coupled to,” or “adjacent to,” another element, the element may be directly on, connected to, coupled to, or adjacent to, the other element, or one or more other intervening elements may be present. In contrast, when an element is referred to as being “directly on,” “directly connected to,” “directly coupled to,” or “immediately adjacent to,” another element there are no intervening elements present.

Unless otherwise defined, all terms (including technical and scientific terms) used herein have the same meaning as commonly understood by one of ordinary skill in the art to which example embodiments belong. Terms, such as those defined in commonly used dictionaries, should be interpreted as having a meaning that is consistent with their meaning in the context of the relevant art and/or this disclosure, and should not be interpreted in an idealized or overly formal sense unless expressly so defined herein.

Example embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail below. Although discussed in a particular manner, a function or operation specified in a specific block may be performed differently from the flow specified in a flowchart, flow diagram, etc. For example, functions or operations illustrated as being performed serially in two consecutive blocks may actually be performed simultaneously, or in some cases be performed in reverse order.

Units and/or devices according to one or more example embodiments may be implemented using hardware and/or a combination of hardware and software. For example, hardware devices may be implemented using processing circuitry such as, but not limited to, a processor, Central Processing Unit (CPU), a controller, an arithmetic logic unit (ALU), a digital signal processor, a microcomputer, a field programmable gate array (FPGA), a System-on-Chip (SoC), a programmable logic unit, a microprocessor, or any other device capable of responding to and executing instructions in a defined manner.

Software may include a computer program, program code, instructions, or some combination thereof, for independently or collectively instructing or configuring a hardware device to operate as desired. The computer program and/or program code may include program or computer-readable instructions, software components, software modules, data files, data structures, and/or the like, capable of being implemented by one or more hardware devices, such as one or more of the hardware devices mentioned above. Examples of program code include both machine code produced by a compiler and higher level program code that is executed using an interpreter.

For example, when a hardware device is a computer processing device (e.g., a processor), Central Processing Unit (CPU), a controller, an arithmetic logic unit (ALU), a digital signal processor, a microcomputer, a microprocessor, etc., the computer processing device may be configured to carry out program code by performing arithmetical, logical, and input/output operations, according to the program code. Once the program code is loaded into a computer processing device, the computer processing device may be programmed to perform the program code, thereby transforming the computer processing device into a special purpose computer processing device. In a more specific example, when the program code is loaded into a processor, the processor becomes programmed to perform the program code and operations corresponding thereto, thereby transforming the processor into a special purpose processor.

Software and/or data may be embodied permanently or temporarily in any type of machine, component, physical or virtual equipment, or computer storage medium or device, capable of providing instructions or data to, or being interpreted by, a hardware device. The software also may be distributed over network coupled computer systems so that the software is stored and executed in a distributed fashion. In particular, for example, software and data may be stored by one or more computer readable storage mediums, including the tangible or non-transitory computer-readable storage media discussed herein.

According to one or more example embodiments, computer processing devices may be described as including various functional units that perform various operations and/or functions to increase the clarity of the description. However, computer processing devices are not intended to be limited to these functional units. For example, in one or more example embodiments, the various operations and/or functions of the functional units may be performed by other ones of the functional units. Further, the computer processing devices may perform the operations and/or functions of the various functional units without sub-dividing the operations and/or functions of the computer processing units into these various functional units.

Units and/or devices according to one or more example embodiments may also include one or more storage devices. The one or more storage devices may be tangible or non-transitory computer-readable storage media, such as random access memory (RAM), read only memory (ROM), a permanent mass storage device (such as a disk drive, solid state (e.g., NAND flash) device, and/or any other like data storage mechanism capable of storing and recording data. The one or more storage devices may be configured to store computer programs, program code, instructions, or some combination thereof, for one or more operating systems and/or for implementing the example embodiments described herein. The computer programs, program code, instructions, or some combination thereof, may also be loaded from a separate computer readable storage medium into the one or more storage devices and/or one or more computer processing devices using a drive mechanism. Such separate computer readable storage medium may include a Universal Serial Bus (USB) flash drive, a memory stick, a Blue-ray/DVD/CD-ROM drive, a memory card, and/or other like computer readable storage media. The computer programs, program code, instructions, or some combination thereof, may be loaded into the one or more storage devices and/or the one or more computer processing devices from a remote data storage device via a network interface, rather than via a local computer readable storage medium. Additionally, the computer programs, program code, instructions, or some combination thereof, may be loaded into the one or more storage devices and/or the one or more processors from a remote computing system that is configured to transfer and/or distribute the computer programs, program code, instructions, or some combination thereof, over a network. The remote computing system may transfer and/or distribute the computer programs, program code, instructions, or some combination thereof, via a wired interface, an air interface, and/or any other like medium.

The one or more hardware devices, the one or more storage devices, and/or the computer programs, program code, instructions, or some combination thereof, may be specially designed and constructed for the purposes of the example embodiments, or they may be known devices that are altered and/or modified for the purposes of example embodiments.

A hardware device, such as a computer processing device, may run an operating system (OS) and one or more software applications that run on the OS. The computer processing device also may access, store, manipulate, process, and create data in response to execution of the software. For simplicity, one or more example embodiments may be exemplified as one computer processing device; however, one skilled in the art will appreciate that a hardware device may include multiple processing elements and multiple types of processing elements. For example, a hardware device may include multiple processors or a processor and a controller. In addition, other processing configurations are possible, such as parallel processors.

Although described with reference to specific examples and drawings, modifications, additions and substitutions of example embodiments may be variously made according to the description by those of ordinary skill in the art. For example, the described techniques may be performed in an order different with that of the methods described, and/or components such as the described system, architecture, devices, circuit, and the like, may be connected or combined to be different from the above-described methods, or results may be appropriately achieved by other components or equivalents.

Hereinafter, example embodiments will be described with reference to the accompanying drawings.

The example embodiments relate to speaker diarization technology combined with speaker identification technology.

The example embodiments including the disclosures described herein may improve speaker diarization performance by combining speaker diarization technology with speaker identification technology.

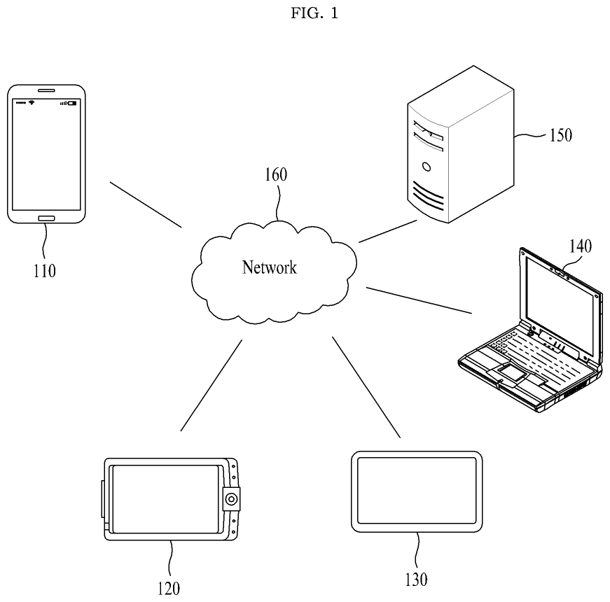

FIG. 1 illustrates an example of a network environment according to at least one example embodiment. Referring to FIG. 1, the network environment may include a plurality of electronic devices 110, 120, 130, and 140, a server 150, and a network 160. FIG. 1 is provided as an example only. The number of electronic devices and the number of servers is not limited thereto.

Each of the plurality of electronic devices 110, 120, 130, and 140 may be a fixed terminal or a mobile terminal that is configured as a computer system. For example, the plurality of electronic devices 110, 120, 130, and 140 may be a smartphone, a mobile phone, a navigation device, a computer, a laptop computer, a digital broadcasting terminal, a personal digital assistant (PDA), a portable multimedia player (PMP), a tablet personal computer (PC), a game console, a wearable device, an Internet of things (IoT) device, a virtual reality (VR) device, an augmented reality (AR) device, and the like. For example, although FIG. 1 illustrates a shape of a smartphone as an example of the electronic device 110, the electronic device 110 used herein may refer to one of various types of physical computer systems capable of communicating with other electronic devices 120, 130, and 140, and/or the server 150 over the network 160 in a wireless or wired communication manner.

The communication scheme is not limited and may include a near field wireless communication scheme between devices as well as a communication scheme using a communication network (e.g., a mobile communication network, wired Internet, wireless Internet, a broadcasting network, a satellite network, etc.) includable in the network 160. For example, the network 160 may include at least one of network topologies that include a personal area network (PAN), a local area network (LAN), a campus area network (CAN), a metropolitan area network (MAN), a wide area network (WAN), a broadband network (BBN), and the Internet. Also, the network 160 may include at least one of network topologies that include a bus network, a star network, a ring network, a mesh network, a star-bus network, a tree or hierarchical network, and the like. However, they are provided as examples only.

The server 150 may be configured as a computer apparatus or a plurality of computer apparatuses that provides an instruction, a code, a file, content, a service, etc., through communication with the plurality of electronic devices 110, 120, 130, and 140 over the network 160. For example, the server 150 may be a system that provides a desired service to the plurality of electronic devices 110, 120, 130, and 140 connected over the network 160. In detail, for example, the server 150 may provide, to the plurality of electronic devices 110, 120, 130, and 140, a service desired by a corresponding application (e.g., a speech recognition-based artificial intelligence meeting minutes service) through an application of a computer program that is installed and runs on the plurality of electronic devices 110, 120, 130, and 140.

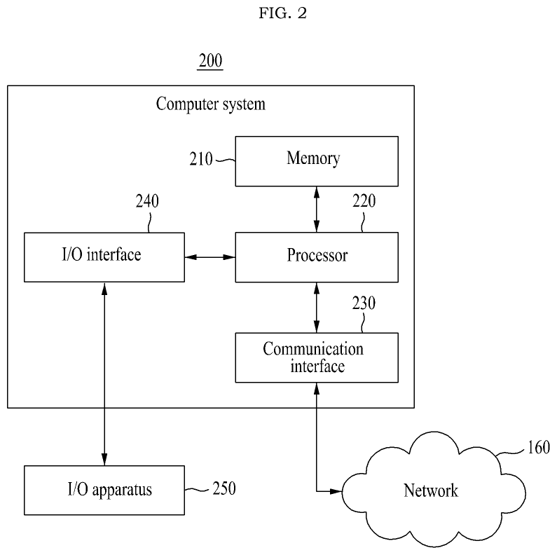

FIG. 2 is a block diagram illustrating an example of a computer system according to at least one example embodiment. The server 150 of FIG. 1 may be implemented by the computer system 200 of FIG. 2.

Referring to FIG. 2, the computer system 200 may include a memory 210, a processor 220, a communication interface 230, and an input/output (I/O) interface 240 as components to perform a speaker diarization method according to example embodiments.

The memory 210 may include a permanent mass storage device, such as a random access memory (RAM), a read only memory (ROM), and a disk drive, as a non-transitory computer-readable record medium. The permanent mass storage device, such as ROM and a disk drive, may be included in the computer system 200 as a permanent storage device separate from the memory 210. Also, an OS and at least one program code may be stored in the memory 210. Such software components may be loaded to the memory 210 from another non-transitory computer-readable record medium separate from the memory 210. The other non-transitory computer-readable record medium may include a non-transitory computer-readable record medium, for example, a floppy drive, a disk, a tape, a DVD/CD-ROM drive, a memory card, etc. According to other example embodiments, software components may be loaded to the memory 210 through the communication interface 230, instead of the non-transitory computer-readable record medium. For example, the software components may be loaded to the memory 210 of the computer system 200 based on a computer program installed by files received over the network 160.

The processor 220 may be configured to process instructions of a computer program by performing basic arithmetic operations, logic operations, and I/O operations. The computer-readable instructions may be provided from the memory 210 or the communication interface 230 to the processor 220. For example, the processor 220 may be configured to execute received instructions in response to the program code stored in the storage device, such as the memory 210.

The communication interface 230 may provide a function for communication between the communication apparatus 200 and another apparatus. For example, the processor 220 of the computer system 200 may forward a request or an instruction created based on a program code stored in the storage device such as the memory 210, data, and a file, to other apparatuses over the network 160 under control of the communication interface 230. Inversely, a signal, an instruction, data, a file, etc., from another apparatus may be received at the computer system 200 through the communication interface 230 of the computer system 200. For example, a signal, an instruction, content, data, etc., received through the communication interface 230 may be forwarded to the processor 220 or the memory 210, and a file, etc., may be stored in a storage medium, for example, the permanent storage device, further includable in the computer system 200.

The communication scheme is not limited and may include a near field wired/wireless communication scheme between devices as well as a communication scheme using a communication network (e.g., a mobile communication network, wired Internet, wireless Internet, a broadcasting network, etc.) includable in the network 160. For example, the network 160 may include at least one of network topologies that include a PAN, a LAN, a CAN, a MAN, a WAN, a BBN, and the Internet. Also, the network 160 may include at least one of network topologies that include a bus network, a star network, a ring network, a mesh network, a star-bus network, a tree or hierarchical network, and the like. However, they are provided as examples only.

The I/O interface 240 may be a device used for interfacing with an I/O apparatus 250. For example, an input device may include a device, such as a microphone, a keyboard, a camera, a mouse, etc., and an output device may include a device, such as a display, a speaker, etc. As another example, the I/O interface 240 may be a device for interfacing with an apparatus in which an input function and an output function are integrated into a single function, such as a touchscreen. The I/O apparatus 250 may be configured as a single apparatus with the computer system 200.

According to other example embodiments, the computer system 200 may include a number of components greater than or less than the number of components shown in FIG. 2. However, there is no need to clearly illustrate many components according to the related art. For example, the computer system 200 may include at least a portion of the I/O apparatus 250, or may further include other components, for example, a transceiver, a camera, various types of sensors, a database, etc.

Hereinafter, example embodiments of a method and system for speaker diarization combined with speaker identification are described.

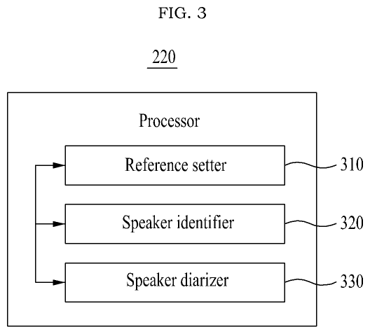

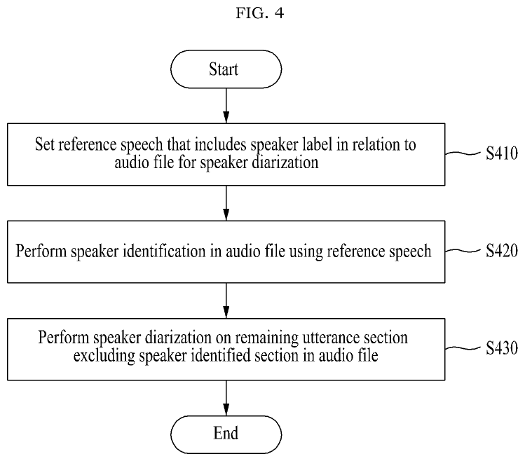

FIG. 3 is a diagram illustrating an example of components includable in a processor of a server according to at least one example embodiment, and FIG. 4 is a flowchart illustrating an example of a method performed by a server according to at least one example embodiment.

The server 150 according to the example embodiment serves as a service platform that provides an artificial intelligence service for organizing an audio file of meeting minutes into a document through a speaker diarization.

A speaker diarization system implemented as the computer system 200 may be configured in the server 150. The server 150 may provide a speech recognition-based artificial intelligence meeting minutes service through access to a website/mobile site related to an exclusive application installed on the electronic devices 110, 120, 130, and 140 or the server 150 for the electronic devices 110, 120, 130, and 140 that are clients.

In particular, the server 150 may improve speaker diarization performance by combining speaker diarization technology with speaker identification technology.

Referring to FIG. 3, as components to perform the speaker diarization method of FIG. 4, the processor 220 of the server 150 may include a reference setter 310, a speaker identifier 320, and a speaker diarizer 330.

Depending on example embodiments, the components of the processor 220 may be selectively included in or excluded from the processor 220. Also, depending on example embodiments, the components of the processor 220 may be separated or merged for representations of functions of the processor 220.

The processor 220 and the components of the processor 220 may control the server 150 to perform operations S410 to S430 included in the speaker diarization method of FIG. 4. For example, the processor 220 and the components of the processor 220 may be configured to execute an instruction according to a code of at least one program and a code of an operating system (OS) included in the memory 210.

Here, the components of the processor 220 may be representations of different functions performed by the processor 220 in response to an instruction provided from the program code stored in the server 150. For example, the reference setter 310 may be used as a functional representation of the processor 220 that controls the server 150 to set a reference speech in response to the instruction.

The processor 220 may read a necessary instruction from the memory 210 to which instructions associated with control of the server 150 are loaded. In this case, the read instruction may include an instruction for controlling the processor 220 to perform the operations S410 to S430 of FIG. 4.

The operations S410 to S430 described below may be performed in an order different from the order illustrated in FIG. 4, and one or more of the operations S410 to S430 may be omitted, or an additional process may be further included.

The processor 220 may receive an audio file from a client and may separate an utterance section for each speaker in the received audio file, and, to this end, may combine speaker diarization technology with speaker identification technology.

Referring to FIG. 4, in operation S410, the reference setter 310 may set a speaker speech (hereinafter, referred to as a “reference speech”) that is referenced in relation to an audio file received as a speaker diarization target speech from a client. The reference setter 310 may set, as the reference speech, speech of one of the speakers among the speakers included in the speaker diarization target speech. Here, the reference speech may use speech data including a speaker label for each speaker to enable speaker identification. For example, the reference setter 310 may receive a label including an utterance speech of a speaker belonging to the speaker diarization target speech and corresponding speaker information through a separate recording, and may set the same as the reference speech. In a recording process, a guide for recording a reference speech, such as a sentence or an environment to be recorded, may be provided and a speech recorded according to the guide may be set as the reference speech. As another example, the reference setter 310 may set the reference speech using a speaker speech that is pre-recorded in a database as a speech of a speaker belonging to the speaker diarization target speech. A speech that enables speaker identification, that is, a speech including a label, may be recorded on a database that is included in the server 150 as a component of the server 150 or implemented as a system separate from the server 150 to be interactable with the server 150. The reference setter 310 may receive, from the client, a selection on a speech of a portion (subset) of the speakers belonging to the speaker diarization target speech among speaker speeches enrolled in the database, and may set the selected speaker speech as the reference speech.

In operation S420, the speaker identifier 320 may perform a speaker identification of identifying a speaker of the reference speech in the speaker diarization target speech using the reference speech set in operation S410. The speaker identifier 320 may compare a corresponding speech section to the reference speech for each utterance section included in the speaker diarization target speech, and may verify an utterance section corresponding to the reference speech and then map a speaker label of the reference speech to the verified utterance section.

In operation S430, the speaker diarizer 330 may perform a speaker diarization on a remaining utterance section (i.e., the section excluding the utterance section in which the speaker has already been identified) among the utterance sections included in the speaker diarization target speech. That is, the speaker diarizer 330 may perform the speaker diarization using clustering on the remaining utterance section after the speaker label of the reference speech is mapped through the speaker identification in the speaker diarization target speech, and may perform an index of a cluster to the corresponding utterance section, as explained in the example provided below.

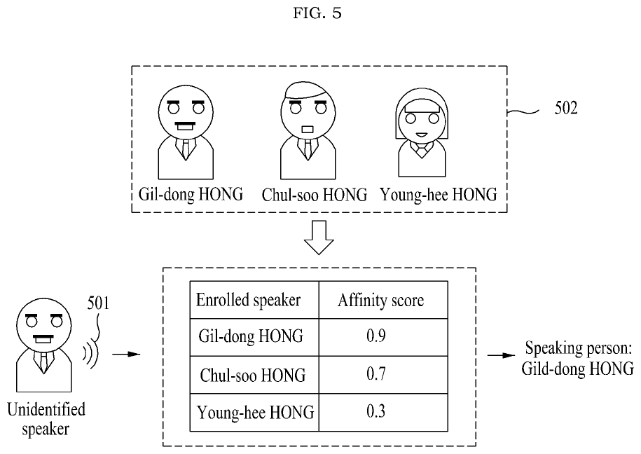

FIG. 5 illustrates an example of a speaker identification process according to at least one example embodiment.

For example, it is assumed that speeches of three speakers (Gil-dong HONG, Chul-soo HONG, and Young-hee HONG) are enrolled.

When an unknown, that is, unidentified speaker speech 501 is received, the speaker identifier 320 may compare the unidentified speaker speech 501 to each of enrolled speaker speeches 502, and may calculate an affinity score with an enrolled speaker. Here, the speaker identifier 320 may identify the unidentified speaker speech 501 as a speech of an enrolled speaker with a highest affinity score, and may map a label of a corresponding speaker to the unidentified speaker speech 501.

Referring to the FIG. 5 example, when an affinity score with Gil-dong HONG is highest among the three enrolled speakers, Gil-dong HONG, Chul-soo HONG, and Young-hee HONG, the unidentified speaker speech 501 may be identified as a speech of Gil-dong HONG.

Therefore, speaker identification technology is to search for a speaker with the most similar speech from among the enrolled speakers.

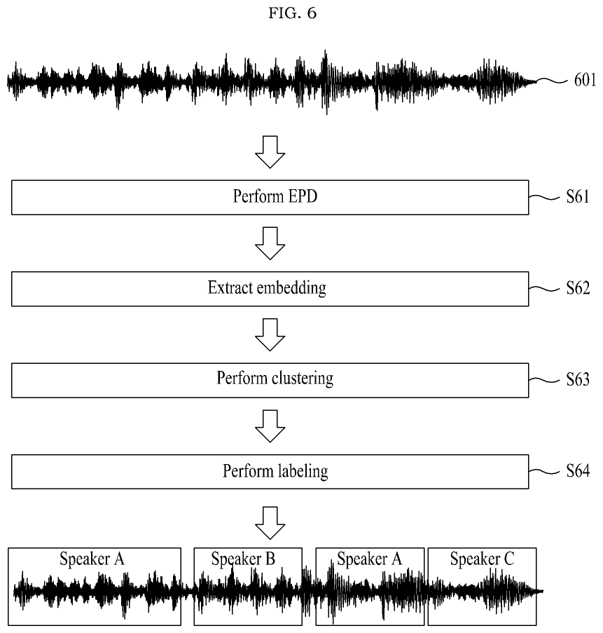

FIG. 6 illustrates an example of a speaker diarization process according to at least one example embodiment.

Referring to FIG. 6, in operation S61, the speaker diarizer 330 performs an end point detection (EPD) process on an audio file 601, where audio file 601 is a speaker diarization target speech that has been received from a client. An EPD process relates to removing an acoustic characteristic of a frame corresponding to a mute section, measuring energy for each frame, and finding only the start and the end of an utterance that distinguishes between a speech and a mute. That is, the speaker diarizer 330 performs the EPD process of finding an area including a speech from the audio file 601 for speaker diarization.

In operation S62, the speaker diarizer 330 performs an embedding extraction process for an EPD result. For example, the speaker diarizer 330 may extract a speaker embedding from the EPD result based on a deep neural network or a long short term memory (LSTM). A speech may be vectorized by learning a unique personality and a biometric characteristic inherent in the speech through deep learning. Through this, a speech of a specific speaker may be separated from the audio file 601

In operation S63, the speaker diarizer 330 may perform clustering for the speaker diarization using an embedding extraction result.

The speaker diarizer 330 calculates an affinity matrix through embedding extraction from the EPD result, and then calculates the number of clusters using the affinity matrix. For example, the speaker diarizer 330 may extract eigenvalues and eigenvectors by performing an eigen decomposition on the affinity matrix, may sort the extracted eigenvalues based on an eigenvalue size, and may determine the number of clusters based on the sorted eigenvalues. Here, the speaker diarizer 330 may determine the number of eigenvalues corresponding to a valid principal component based on a difference between adjacent eigenvalues among the sorted eigenvalues as the number of clusters. A high eigenvalue represents a great influence in the affinity matrix, that is, represents that an utterance weight is high among speakers having utterances when configuring the affinity matrix for the audio file 601. That is, the speaker diarizer 330 may select an eigenvalue having a sufficiently large value from among the sorted eigenvalues, and may determine the number of the selected eigenvalues as the number of clusters representing the number of speakers.

The speaker diarizer 330 may perform a speaker diarization clustering using the affinity matrix and the number of clusters. The speaker diarizer 330 may perform clustering based on eigenvectors that are sorted based on eigenvalues by performing the eigen decomposition on the affinity matrix. When m speaker speech sections are extracted from the audio file 601, a matrix including m×m elements is generated. Here, v_{i,j} denotes each element and represents a distance between an i^{th} speech section and a j^{th} speech section. Here, the speaker diarizer 330 may perform speaker diarization clustering by selecting a number of eigenvectors as many as the determined number of clusters.

As a representative clustering method, for example, agglomerative hierarchical clustering (AHC), K-means, and a spectrum clustering algorithm may be applied.

In operation S64, the speaker diarizer 330 may perform speaker diarization labeling by mapping an index of a cluster to a speech section according to clustering. When three clusters are determined from the audio file 601, the speaker diarizer 330 may map an index of each of the clusters, for example, each of A, B, and C to a corresponding speech section.

Therefore, speaker diarization technology analyzes information using unique speech characteristics for each person from speeches in which a plurality of speakers are mixed, and segmentizes the information into speech fragments corresponding to the respective speakers. For example, the speaker diarizer 330 may extract characteristics containing information of a speaker from each speech section detected from the audio file 601 and may cluster the characteristics into a speech for each speaker.

The example embodiments are to improve the speaker diarization performance by combining the speaker identification technology of FIG. 5 and the speaker diarization technology of FIG. 6.

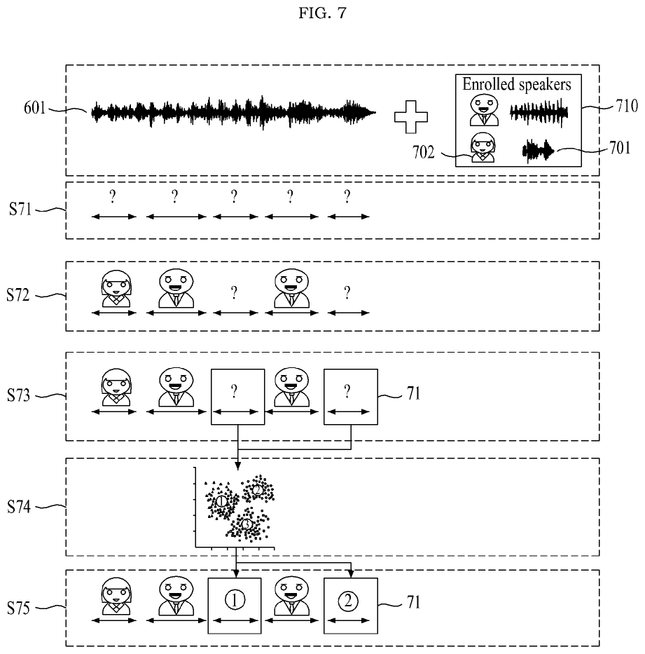

FIG. 7 illustrates an example of a combination of a speaker diarization process and a speaker identification process is combined according to at least one example embodiment.

Referring to FIG. 7, the processor 220 may receive, from a client, a reference speech 710 that is an enrolled speaker speech with the speaker diarization target speech that is the audio file 601. The reference speech 710 may be a speech of a portion (subset) of speakers included in the speaker diarization target speech (hereinafter, referred to as an enrolled speaker) and may use speech data 701 that includes a speaker label 702 for each enrolled speaker.

In operation S71, the speaker identifier 320 may detect an utterance section by performing an EPD process on the speaker diarization target speech and may extract a speaker embedding for each utterance section. An embedding for each enrolled speaker may be included in the reference speech 710. Alternatively, in operation S71 that is a speaker embedding process, a speaker embedding of the reference speech 710 may be extracted with the speaker diarization target speech.

In operation S72, the speaker identifier 320 may compare the reference speech 710 and an embedding for each utterance section included in the speaker diarization target speech and may verify an utterance section corresponding to the reference speech 710. Here, the speaker identifier 320 may map the speaker label of the reference speech 710 to an utterance section of which an affinity with the reference speech 710 is greater than or equal to a set value in the speaker diarization target speech.

In operation S73, the speaker diarizer 330 may distinguish an utterance section in which a speaker is identified (i.e., a speaker label mapping is completed) from a remaining utterance section 71 in which a speaker is unidentified through a speaker identification using the reference speech 710 in the speaker diarization target speech.

In operation S74, the speaker diarizer 330 may perform speaker diarization clustering only on the remaining utterance section 71 in which the speaker is unidentified in the speaker diarization target speech.

In operation S75, the speaker diarizer 330 may complete speaker labeling by mapping an index of a corresponding cluster to each utterance section according to speaker diarization clustering.

Therefore, the speaker diarizer 330 may perform the speaker diarization using clustering on the remaining utterance section 71 after mapping the speaker label of the reference speech 710 through the speaker identification in the speaker diarization target speech and may map the index of the cluster.

Hereinafter, a method of verifying an utterance section corresponding to the reference speech 710 in the speaker diarization target speech that is the audio file 601 is described.

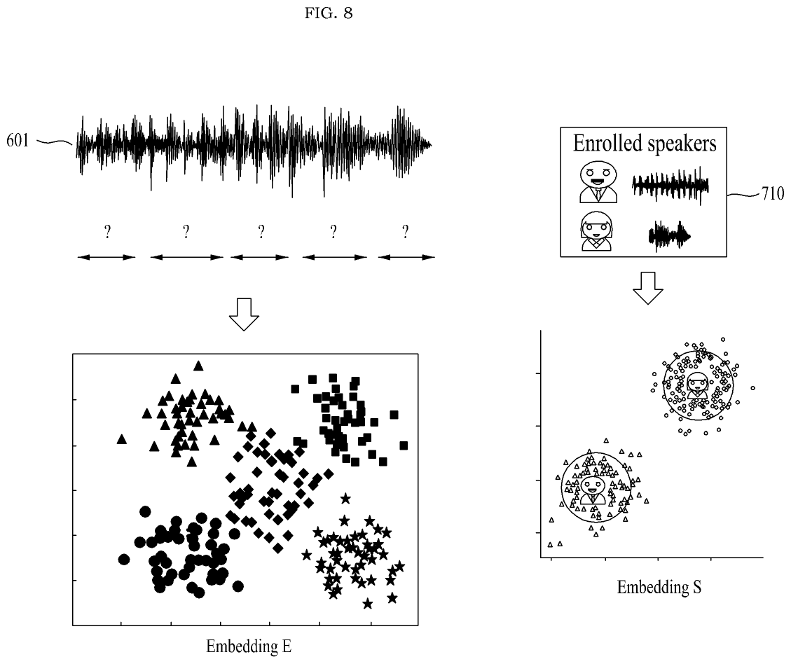

For example, referring to FIG. 8, the speaker identifier 320 may verify an utterance section corresponding to the reference speech 710 based on a distance between Embedding E extracted from each utterance section of the speaker diarization target speech that is the audio file 601 and Embedding S extracted from the reference speech 710. For example, with the assumption that the reference speech 710 includes a speech of Speaker A and a speech of Speaker B, the speaker identifier 320 may map Speaker A to an utterance section of Embedding E in which a distance from Embedding S_{A} of Speaker A is less than or equal to a threshold and may map Speaker B to an utterance section of Embedding E in which a distance from Embedding S_{B} of Speaker B is less than or equal to the threshold. The remaining section is classified as unknown, that is, as an unidentified utterance section.

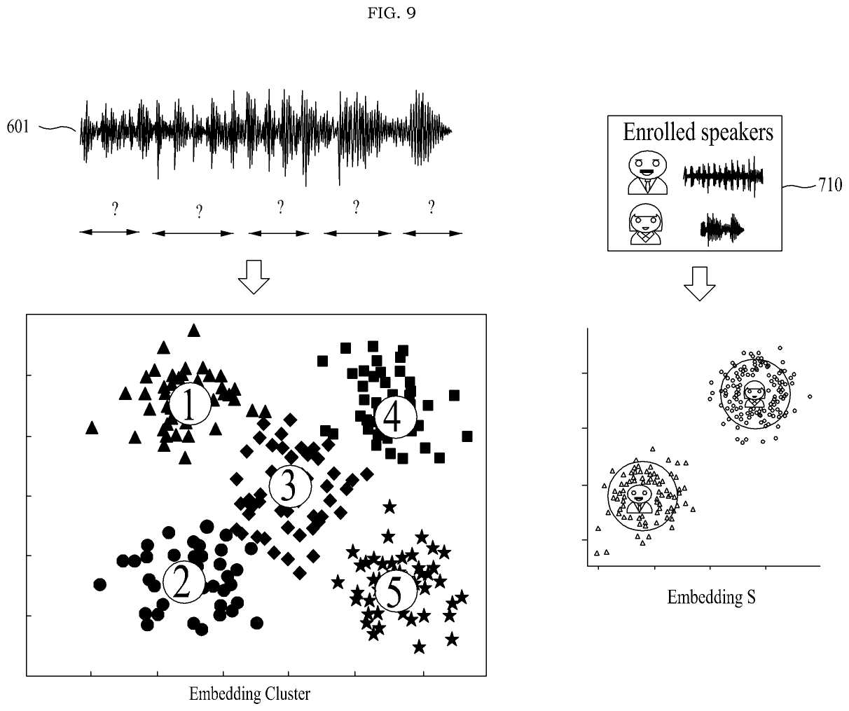

As another example, referring to FIG. 9, the speaker identifier 320 may verify an utterance section corresponding to the reference speech 710 based on a distance between an Embedding Cluster that is a result of clustering an embedding for each utterance section of the speaker diarization target speech that is the audio file 601 and Embedding S extracted from the reference speech 710. For example, when it is assumed that five clusters are formed for the speaker diarization target speech and the reference speech 710 includes a speech of Speaker A and a speech of Speaker B, the speaker identifier 320 maps Speaker A to utterance sections of clusters \textcircled{1} and \textcircled{5} in which a distance from Embedding S_{A} of Speaker A is less than or equal to a threshold and maps Speaker B to an utterance section of cluster \textcircled{3} in which a distance from Embedding S_{B} of Speaker B is less than or equal to the threshold. The remaining sections are classified as unidentified utterance sections.

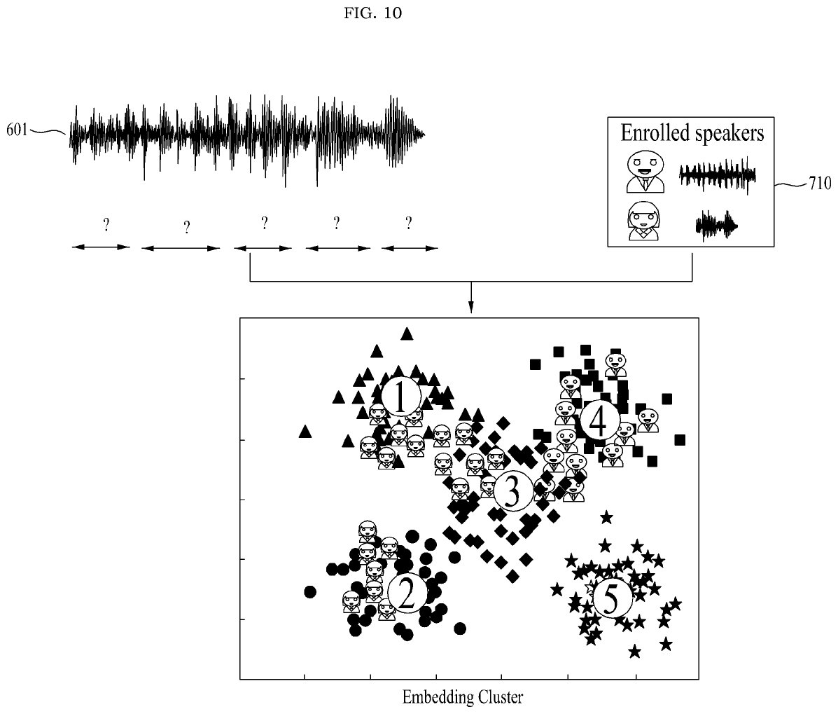

As another example, referring to FIG. 10, the speaker identifier 320 may verify an utterance section corresponding to the reference speech 710 by clustering an embedding extracted from each utterance section of the speaker diarization target speech that is the audio file 601 and an embedding extracted from the reference speech 710. For example, when it is assumed that the reference speech 710 includes a speech of Speaker A and a speech of Speaker B, the speaker identifier 320 maps Speaker A to an utterance section of cluster \textcircled{4} that includes Embedding S_{A} of Speaker A and maps Speaker B to clusters \textcircled{1} and \textcircled{2} that include Embedding S_{B} of Speaker B. The remaining sections that commonly include Embedding S_{A} of Speaker A and Embedding S_{B} of Speaker B or that includes neither thereof are classified as unidentified utterance sections.

To determine an affinity with the reference speech 710, various distance functions, such as Single, complete, average, weighted, centroid, median, and ward functions, applicable to a clustering scheme may be used.

Through the speaker identification using the above verification methods, the speaker diarization using clustering is performed on an utterance section remaining after mapping the speaker label of the reference speech 710, that is, a section that is classified into an identified utterance section.

According to some example embodiments, it is possible to improve speaker diarization performance by combining speaker diarization technology with speaker identification technology. According to some example embodiments, it is possible to improve accuracy of speaker diarization technology by performing a speaker identification and then performing a speaker diarization using a reference speech including a speaker label.

The apparatuses described herein may be implemented using hardware components, software components, and/or a combination thereof. For example, a processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For the purpose of simplicity, the description of a processing device is used as singular; however, one skilled in the art will appreciated that a processing device may include multiple processing elements and/or multiple types of processing elements. For example, a processing device may include multiple processors or a processor and a controller. In addition, different processing configurations are possible, such as parallel processors.

The software may include a computer program, a piece of code, an instruction, or some combination thereof, for independently or collectively instructing or configuring the processing device to operate as desired. Software and/or data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. In particular, the software and data may be stored by one or more computer readable storage mediums.

The methods according to the example embodiments may be recorded in non-transitory computer-readable media including program instructions to implement various operations embodied by a computer. The media may also include, alone or in combination with the program instructions, data files, data structures, and the like. The media and program instructions may be those specially designed and constructed for the purposes, or they may be of the kind well-known and available to those having skill in the computer software arts. Examples of non-transitory computer-readable media include magnetic media such as hard disks, floppy disks, and magnetic tape; optical media such as CD ROM disks and DVD; magneto-optical media such as floptical disks; and hardware devices that are specially to store and perform program instructions, such as read-only memory (ROM), random access memory (RAM), flash memory, and the like. Examples of other media may include recording media and storage media managed by an app store that distributes applications or a site, a server, and the like that supplies and distributes other various types of software. Examples of program instructions include both machine code, such as produced by a compiler, and files containing higher level code that may be executed by the computer using an interpreter.

The foregoing description has been provided for purposes of illustration and description. It is not intended to be exhaustive or to limit the disclosure. Individual elements or features of a particular example embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A speaker diarization method executed by a computer system comprising at least one processor configured to execute computer-readable instructions included in a memory, the speaker diarization method, which uses the at least one processor, comprising:
receiving an audio file including a diarization target speech from a client;
setting a reference speech in relation to the audio file received from the client;
performing a speaker identification of identifying a speaker of the reference speech in the audio file using the reference speech; and
performing a speaker diarization using clustering on any remaining unidentified utterance sections in the audio file.

2. The speaker diarization method of claim 1, wherein the setting of the reference speech comprises setting speech data including a label of a portion of speakers included in the audio file as the reference speech.

3. The speaker diarization method of claim 1, wherein the setting of the reference speech comprises receiving a selection on a speech of a portion of speakers included in the audio file from among speaker speeches pre-stored in a database related to the computer system and setting the selected speech as the reference speech.

4. The speaker diarization method of claim 1, wherein the setting of the reference speech comprises receiving an input of a speech of a portion of speakers included in the audio file through recording and setting the input speech as the reference speech.

5. The speaker diarization method of claim 1, wherein the performing of the speaker identification comprises:
verifying an utterance section corresponding to the reference speech from among utterance sections included in the audio file; and
mapping a speaker label of the reference speech to the utterance section corresponding to the reference speech.

6. The speaker diarization method of claim 5, wherein the verifying comprises verifying the utterance section corresponding to the reference speech based on a distance between an embedding extracted from the utterance section and an embedding extracted from the reference speech.

7. The speaker diarization method of claim 5, wherein the verifying comprises verifying the utterance section corresponding to the reference speech based on a distance between an embedding cluster that is a result of clustering an embedding extracted from the utterance section and an embedding extracted from the reference speech.

8. The speaker diarization method of claim 5, wherein the verifying comprises verifying the utterance section corresponding to the reference speech based on a result of clustering an embedding extracted from the reference speech with an embedding extracted from the utterance section.

9. The speaker diarization method of claim 1, wherein the performing of the speaker diarization comprises:
clustering an embedding extracted from the remaining utterance section; and
mapping an index of a cluster to the remaining utterance section.

10. The speaker diarization method of claim 9, wherein the clustering comprises:
calculating an affinity matrix based on the embedding extracted from the remaining utterance section;
extracting eigenvalues by performing an eigen decomposition on the affinity matrix;
sorting the extracted eigenvalues and determining a number of eigenvalues selected based on a difference between adjacent eigenvalues as a number of clusters; and
performing a speaker diarization clustering using the affinity matrix and the number of clusters.

11. A non-transitory computer-readable record medium storing instructions that, when executed by a processor, cause the processor to computer-implement the speaker diarization method of claim. 1.

12. A computer system comprising:
at least one processor configured to execute computer-readable instructions included in a memory,
wherein the at least one processor comprises:
a reference setter configured to set a reference speech in relation to an audio file received as a speaker diarization target speech from a client;
a speaker identifier configured to perform speaker identification of identifying a speaker of the reference speech in the audio file using the reference speech; and
a speaker diarizer configured to perform speaker diarization using clustering on a remaining unidentified utterance section of the audio file.

13. The computer system of claim 12, wherein the reference setter is configured to set speech data including a label of a portion of speakers included in the audio file as the reference speech.

14. The computer system of claim 12, wherein the reference setter is configured to receive a selection on a speech of a portion of speakers included in the audio file from among speaker speeches pre-stored in a database related to the computer system and to set the selected speech as the reference speech.

15. The computer system of claim 12, wherein the reference setter is configured to receive an input of a speech of a portion of speakers included in the audio file through recording and to set the input speech as the reference speech.

16. The computer system of claim 12, wherein the speaker identifier is configured to:
verify an utterance section corresponding to the reference speech from among utterance sections included in the audio file, and
map a speaker label of the reference speech to the utterance section corresponding to the reference speech.

17. The computer system of claim 16, wherein the speaker identifier is configured to verify the utterance section corresponding to the reference speech based on a distance between an embedding extracted from the utterance section and an embedding extracted from the reference speech.

18. The computer system of claim 16, wherein the speaker identifier is configured to verify the utterance section corresponding to the reference speech based on a distance between an embedding cluster that is a result of clustering an embedding extracted from the utterance section and an embedding extracted from the reference speech.

19. The computer system of claim 16, wherein the speaker identifier is configured to verify the utterance section corresponding to the reference speech based on a result of clustering an embedding extracted from the reference speech with an embedding extracted from the utterance section.

20. The computer system of claim 12, wherein the speaker diarizer is configured to:
calculate an affinity matrix based on the embedding extracted from the remaining utterance section,
extract eigenvalues by performing an eigen decomposition on the affinity matrix,
sort the extracted eigenvalues and determine a number of eigenvalues selected based on a difference between adjacent eigenvalues as a number of clusters,
perform a speaker diarization clustering using the affinity matrix and the number of clusters, and
map an index of a cluster according to the speaker diarization clustering to the remaining utterance section.
